(19) United States
(12) Patent Application Publication
(10) Pub. No.: US 2016/0306697 A1
(43) Pub. Date: Oct. 20, 2016

(54) MAGNETIC DISK DEVICE AND METHOD FOR SAVING MANAGEMENT INFORMATION

(71) Applicant: Kabushiki Kaisha Toshiba, Tokyo (JP)

(72) Inventors: Satoru Adachi, Kawasaki Kanagawa (JP); Masaaki Motoki, Yokohama Kanagawa (JP); Mitsuaki Sudou, Yokohama Kanagawa (JP)

(21) Appl. No.: 14/687,274

(22) Filed: Apr. 15, 2015

(51) Int. Cl. G06F 11/10; G11B 20/12; G11B 20/18

(52) U.S. Cl. CPC G06F 11/1076; G11B 20/1833; G11B 20/1252; G11B 2020/1843; G11B 2020/1267

(57) ABSTRACT

According to one embodiment, a controller in a magnetic disk device saves a write data sequence including a plurality of write data blocks not written to a disk, and first management information, for the plurality of write data blocks, from which logical block addresses are excluded, in a nonvolatile memory in response to a decrease in a voltage of a power supply for the magnetic disk device. The plurality of write data blocks are added with redundancy codes respectively. Logical block addresses of the plurality of write data blocks are embedded in the redundancy codes respectively.

### CROSS-REFERENCE TO RELATED APPLICATIONS

This application claims the benefit of U.S. Provisional Application No. 62/115,934, filed Feb. 13, 2015, the entire contents of which are incorporated herein by reference.

### FIELD

Embodiments described herein relate generally to a magnetic disk device and a method for saving management information.

### BACKGROUND

In general, in magnetic disk devices, data with a data length specified in a write command from a host device (in other words, write data) is written to a disk in accordance with the write command. However, a power supply voltage (more specifically, a main power supply voltage) applied to the magnetic disk device may decrease before writing of the write data to the disk is complete. In this case, part of the write data (more specifically, write data not yet written to the disk) may be lost.

Thus, recent magnetic disk devices have a power loss protection (PLP) function to ensure write data even when the main power supply voltage decreases. The PLP function includes a function to save write data not yet written to the disk and management information for the write data (in other words, write data management information), in a nonvolatile memory when the main power supply is restored. Such a saving operation is referred to as a PLP saving operation. The PLP saving operation enables the write data saved in the nonvolatile memory to be restored to a volatile memory based on the write data management information saved in the nonvolatile memory when the main power supply is restored.

As described above, in the PLP saving operation, the write data management information is saved, in addition to the write data, in the nonvolatile memory. The saving of the write data management information brings pressure on a storage area of the nonvolatile memory. Thus, there has been a demand for a reduction in the amount of write data management information to be saved in the nonvolatile memory.

### BRIEF DESCRIPTION OF THE DRAWINGS

FIG. 1 is a block diagram showing an exemplary configuration of a magnetic disk device according to an embodiment;

FIG. 2 is a flowchart showing an exemplary procedure for a saving process in the embodiment;

FIG. 3 is a flowchart showing an exemplary procedure for a block cyclic redundancy check code (BCRC) generation process in the embodiment;

FIG. 4 is a diagram showing an example of contents of a buffer memory and a CPU memory on which the saving process has not been executed and contents of a flash ROM (FROM) on which the saving process has been executed;

FIG. 5 is a flowchart showing an exemplary procedure for a restoration process in the embodiment;

FIG. 6 is a flowchart showing an exemplary procedure for a logical block address (LBA) calculation process included in the restoration process;

FIG. 7 is a diagram illustrating the restoration process;

FIG. 8 is a diagram illustrating the BCRC generation process and the LBA calculation process;

FIG. 9 is a diagram showing an example of contents of the buffer memory and the CPU memory on which the saving process has not been executed and contents of the FROM on which the saving process has been executed, in a modification of the embodiment; and

FIG. 10 is a diagram illustrating a restoration process in the modification.

### DETAILED DESCRIPTION

Various embodiments will be described hereinafter with reference to the accompanying drawings.

In general, according to one embodiment, a magnetic disk device comprises a first volatile memory, a nonvolatile memory, and a controller. The controller is configured to save a write data sequence including a plurality of write data blocks not written to a disk, and first management information, for the plurality of write data blocks, from which logical block addresses are excluded, in the nonvolatile memory in response to a decrease in a voltage of a power supply for the magnetic disk device. The plurality of write data blocks are externally transferred and stored in the first volatile memory and added with redundancy codes respectively. The redundancy codes are associated with the plurality of write data blocks respectively, and logical block addresses of the plurality of write data blocks are embedded in the redundancy codes respectively.

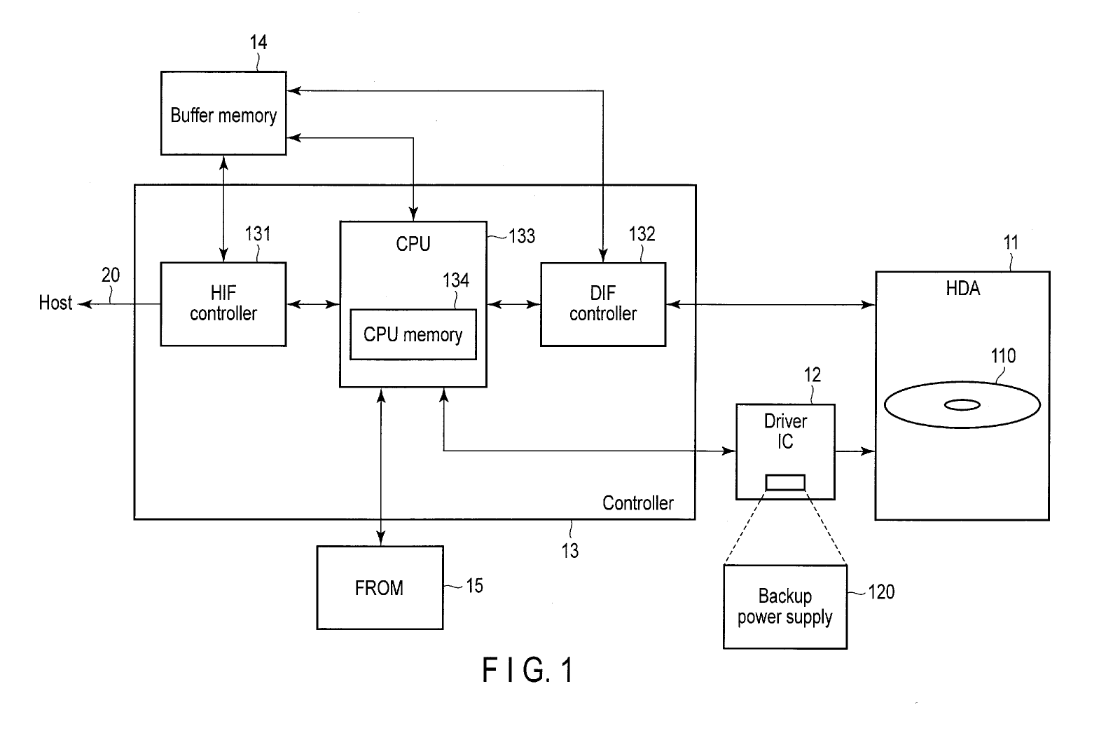

FIG. 1 is a block diagram showing an exemplary configuration of a magnetic disk device according to a embodiment. The magnetic disk device is also referred to as a hard disk drive (HDD). Thus, the magnetic disk device is hereinafter represented as the HDD. The HDD shown in FIG. 1 comprises a head disk assembly (HDA) 11, a driver IC 12, a controller 13, a buffer memory 14, and a flash ROM (FROM) 15.

The HDA 11 includes a disk 110. The disk 110 is, for example, a magnetic recording medium comprising, on one surface, a recording surface on which data is magnetically recorded. The HDA 11 further includes well-known elements such as a head, a spindle motor, and an actuator. However, these elements are omitted from FIG. 1.

The driver IC 12 drives the spindle motor and the actuator in accordance with control of the controller 13 (more specifically, a CPU 133 in the controller 13). The driver IC 12 includes, for example, a backup power supply 120. However, a part (for example, a rectifier circuit) of the backup power supply 120 may be provided outside the driver IC 12.

The backup power supply 120 generates power when the voltage of a power supply for the HDD (hereinafter referred to as a main power supply), in other words, the main power supply voltage, decreases. That is, when the main power supply voltage decreases, the backup power supply 120 generates power required to maintain the minimum required operation of the HDD. The minimum required operation includes a PLP saving operation. The generated power is supplied to at least the controller 13 in the HDD. The backup power supply 120 uses back electromotive force of the spindle motor to generate the power. However, the backup power supply 120 may generate power using a capacitor charged by the main power supply voltage.

The controller 13 is implemented using, for example, a large-scale integrated circuit (LSI) with a plurality of elements integrated on a single chip, called a system-on-a-chip (SOC). The controller 13 includes a host interface controller (hereinafter referred to as an HIF controller) 131, a disk interface controller (hereinafter referred to as a DIF controller) 132, and a CPU 133.

The HIF controller 131 is connected to a host device (hereinafter referred to as a host) via a host interface 20. The HIF controller 131 receives commands (a write command, a read command, and the like) transferred by the host. The HIF controller 131 controls data transfer between the host and the buffer memory 14.

The CPU 133 functions as a main controller for the HDD shown in FIG. 1. The CPU 133 controls at least some of the other elements in the HDD in accordance with a control program. The at least some elements include the driver IC 12, the HIF controller 131, and the DIF controller 132. In the embodiment, the control program is prestored in a particular area of the disk 110. However, the control program may be prestored in the FROM 15.

The CPU 133 includes a CPU memory 134. The CPU memory 134 is configured using a volatile memory such as a static RAM (SRAM) or a dynamic RAM (DRAM). At least a part of the control program is loaded from the disk 110 into a part of the storage area in the CPU memory 134 when, for example, the main power supply for the HDD is turned on. Another part of the storage memory in the CPU memory 134 is used to store management information for write data transferred to the HDD (in other words, write data management information) by the host.

The buffer memory 14 is configured using a volatile memory such as a DRAM. The buffer memory 14 is used to temporarily store write data transferred by the host and read data read from the disk 110. The write data management information, the write data, and the read data may be stored in one volatile memory.

The FROM 15 is a rewritable nonvolatile memory. In the embodiment, an initial program loader is prestored in a part of the storage area in the FROM 15. The CPU 133 loads, into the CPU memory 134, at least a part of the control program stored in the disk 11 by executing the IPL when, for example, the main power supply for the HDD is turned on.

Another part of the storage area in the FROM 15 is used for saving of write data stored in the buffer memory 14 and not yet written to the disk 110 when the main power supply voltage is, for example, lower than a threshold for a given time or longer. Yet another part of the storage area in the FROM 15 is used for saving of write data management information for the write data saved in the FROM 15. The buffer memory 14 and the FROM 15 may be provided in the controller 13.

In the embodiment, when the main power supply voltage decreases as described above, for example, when the main power supply is shut down, the CPU 133 receives power temporarily supplied by the backup power supply 120 to perform the minimum required operation for the HDD. The minimum required operation, for example, includes a PLP saving operation (hereinafter referred to as a saving process) in addition to an operation of retracting the head to a position away from the disk 110. Furthermore, when the main power supply voltage is recovered, for example, when the main power supply is restored, the CPU 133 performs a restoration operation referred to as a PLP restoration operation (hereinafter referred to as a restoration process).

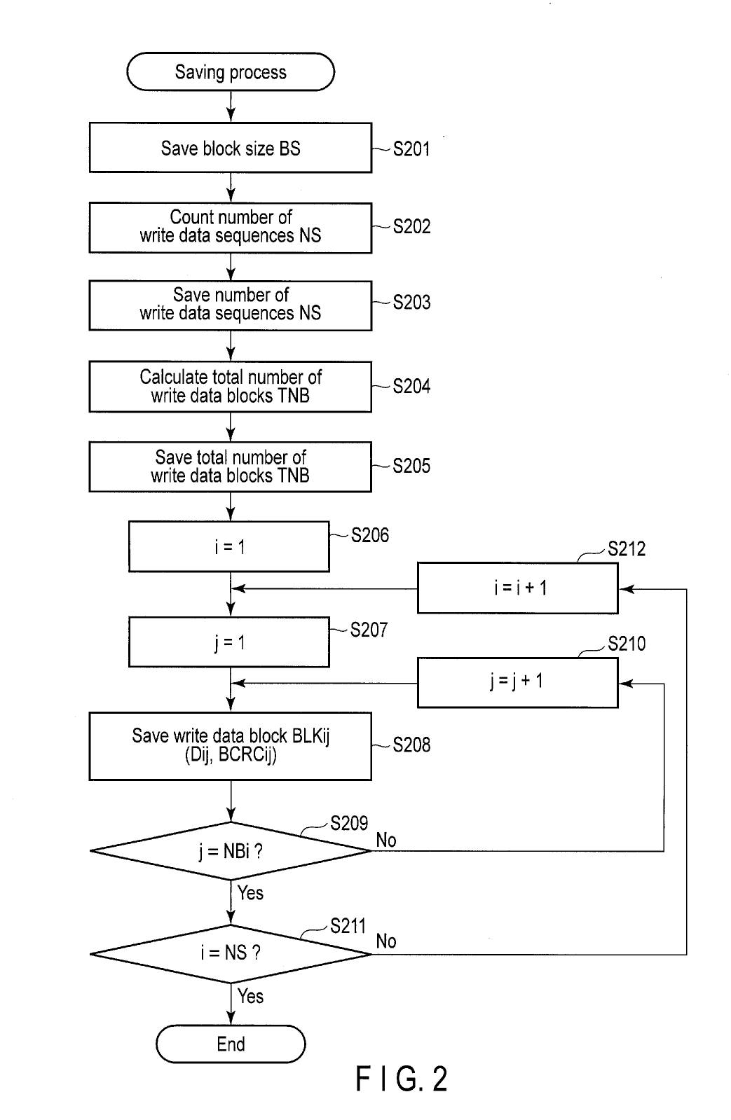

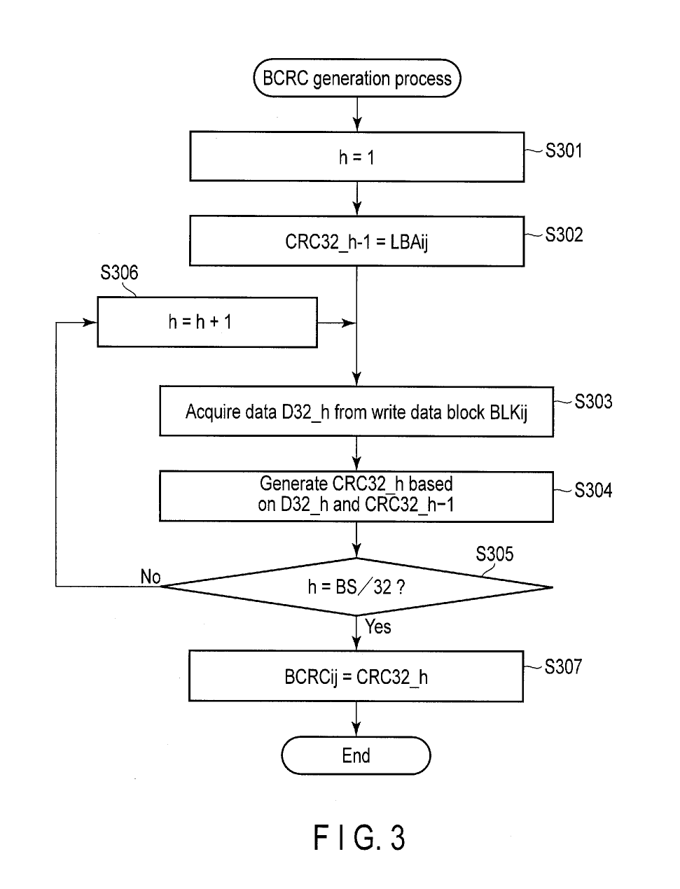

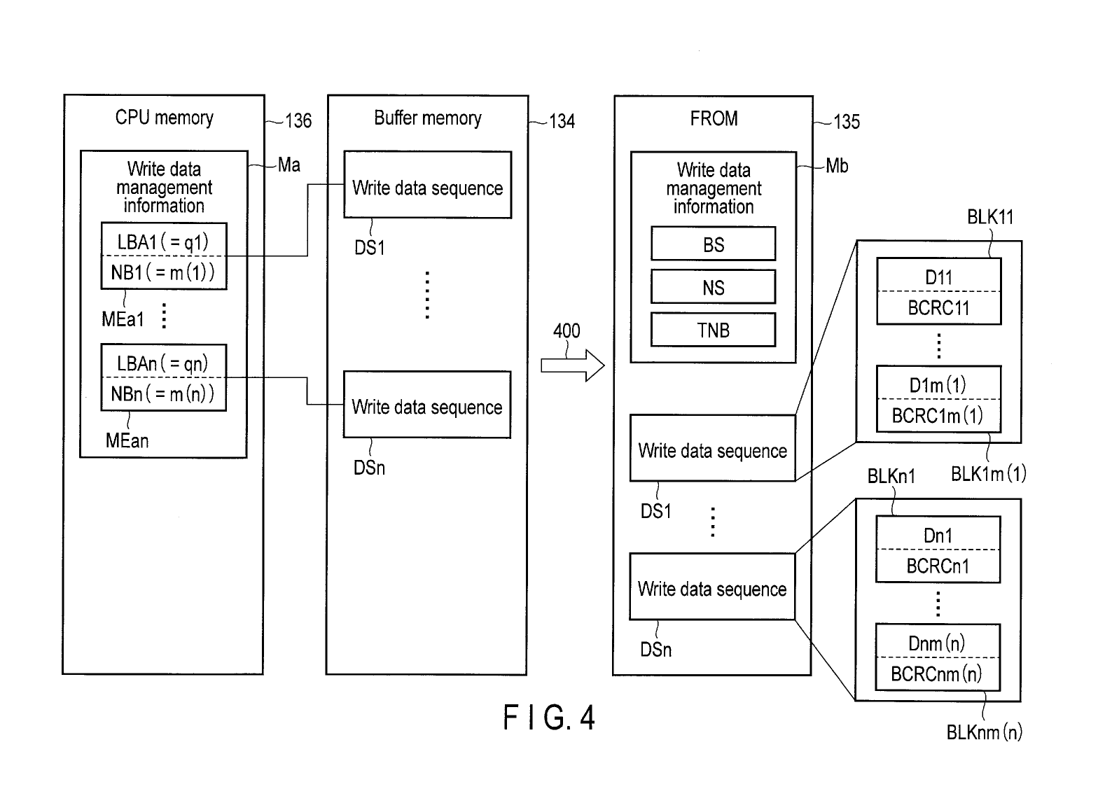

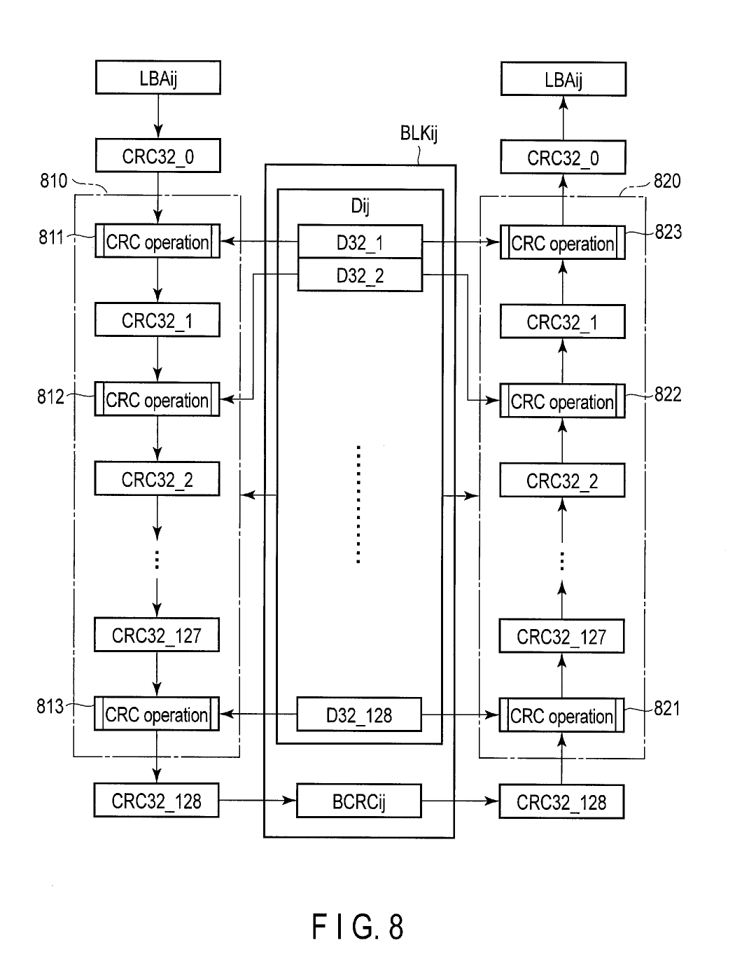

The saving process according to the embodiment will be described below with reference to FIGS. 2 to 4 and FIG. 8. FIG. 2 is a flowchart showing an exemplary procedure for the saving process. FIG. 3 is a flowchart showing an exemplary procedure for a block cyclic redundancy check code (BCRC) generation process. FIG. 4 shows an example of the contents of the buffer memory 14 and the CPU memory 134 on which a saving process shown by arrow 400 has not been executed and the contents of the FROM 15 on which the saving process has been executed. FIG. 8 is a diagram illustrating the BCRC generation process and a logical block address (LBA) calculation process.

It is assumed that the saving process is started by the CPU 133. It is assumed that, at this time, n write data sequences DS1, . . . , DSn are stored in the buffer memory 14 as shown in FIG. 4. Furthermore, it is assumed that write data sequences DS1, . . . , DSn in the buffer memory 14 is not yet written to the disk 110. Write data sequence DSi (i=1, . . . , n) comprises m(i) (=NBi) write data blocks BLKil, . . . , BLKim(i).

The storage positions, in the buffer memory 14, of the write data blocks in write data sequences DS1, . . . , DSn are managed using, for example, a well-known cache directory management table. The cache directory management table is also indicative of whether write data sequences DS1, . . . , DSn in the buffer memory 14 is not yet written to the disk 110, in other words, write data sequences DS1, . . . , DSn are dirty. The cache directory management table may be indicative of whether each of the write data blocks in write data sequences DS1, . . . , DSn is dirty.

The addresses of write data blocks BLKil, . . . , BLKim(i), for example, logical block addresses LBAil, . . . , LBAim(i), are consecutive. Furthermore, for example, a logical block address LBA(i−1)m(i−1) and a logical block address LBAil are assumed to be non-consecutive. LBA(i−1)m(i−1) is the logical block address of a final write data block BLK(i−1)m(i−1) in a write data sequence DS(i−1). Similarly, a logical block address LBAim(i) and a logical block address LBA(i+1)1 are assumed to be non-consecutive. LBA(i+1)1 is the logical block address of a leading write data block BLK(i+1)1 in a write data sequence DS(i+1).

The logical block addresses applied in the embodiment, such as logical block address LBLBAil, . . . , LBAim(i), have a bit length of 32. In this case, the maximum storage capacity that can be supported by the HDD shown in FIG. 1 is approximately 2 TB (terabytes).

In the embodiment, DS1, . . . , DSn are assumed to be write data sequences specified by write commands CMD1, . . . , CMDn from the host (exterior). Write command CMDi includes a logical block address LBAi and a data transfer length. Logical block address LBAi is indicative of logical block address LBAil of a write data block BLKi1 in write data sequence DSi. The data transfer length is indicative of the total number NBi (=m(i)) of write data blocks in write data sequence DSi.

Write data sequences DS1, . . . , DSn are sequentially transferred by the host and received by the HIF controller 131. The HIF controller 131 stores the received write data sequences DS1, . . . , DSn in the buffer memory 14 as shown in FIG. 4. The CPU 133 stores write data management information Ma for write data sequences DS1, . . . , DSn stored in the buffer memory 14, in the CPU memory 134. Write data management information Ma includes write data management information elements MEa1, . . . , MEan corresponding to the respective write data sequences DS1, . . . , DSn, respectively. As shown in FIG. 4, the elements MEa1, . . . , MEan include logical block addresses LBA1 (=q1), . . . LBAn (=qn) and the numbers of write data blocks NB1 (=m(1)), . . . , NBn (=m(n)), respectively.

Now, it is assumed that LBAx is indicative of the logical block address of a final write data block in a first write data sequence specified by a first write command and that LBAy is indicative of the logical block address of a leading write data block in a second write data sequence specified by a second write command. If LBAy is consecutive with LBAx, the CPU 133 merges the first and second write data sequences into a third write data sequence. The CPU 133 merges the first and second write data management information elements corresponding to the first and second write data sequences into a third write data management information element corresponding to the third write data sequence. The logical block address and the number of data blocks in the third write data management information element are indicative of the logical block address of a leading write data block in the third write data sequence and the total number of write data blocks in the third write data sequence, respectively. The above-described write data sequences DS1, . . . , DSn and write data management information elements MEa1, . . . , MEan may include a write data sequence and a write data management information element corresponding to the third write data sequence and the third write data management information element.

Now, it is assumed that BLKij is indicative of the jth (j=1, . . . , m(i)) write data block in write data sequence DSi stored in the buffer memory 14. Write data block BLKij is provided with a block cyclic redundancy check code BCRCij. BCRCij is generated in a BCRC generation process executed by the HIF controller 131 when write data block BLKij is received.

The HIF controller 131 executes the BCRC generation process in accordance with a procedure shown in the flowchart in FIG. 3, as follows. First, the HIF controller 131 sets a variable h to an initial value of 1 (S301). In the embodiment, write data block BLKij is divided into small blocks each with a bit length of 32. In the embodiment, write data block BLKij has a size of 4,096 bits. In this case, write data block BLKij is divided into 128 small blocks. Variable h points to the h^{th} small block of the 128 small blocks in write data block BLKij. Data (data item) in write data block BLKij is represented as Dij. Data (data item) in the h^{th} small block is represented as D32_h. The bit length of the small block (data D32_h) is equal to the bit length of the logical block address applied in the embodiment.

Upon setting variable h to the initial value of 1 (S301), the HIF controller 131 sets logical block address LBAij of write data block BLKij as a 32-bit cyclic redundancy check code CRC32_h−1 (S302). Logical block address LBAij is calculated by a calculation LBAij=LBAi+j−1 based on logical block address LBAi in write data management information element MEai corresponding to write data sequence DSi and on variable j. In this regard, logical block address LBAi is equal to logical block address LBAi1. In the embodiment, in which h is 1, CRC32_h−1=CRC32_0. In other words, LBAij is set as CRC32_0 as shown in FIG. 8.

Then, the HIF controller 131 acquires the data D32_h (=D32_1) in the h^{th} small block from write data block BLKij (S303). Then, the HIF controller 131 performs a CRC operation based on D32_h and CRC32_h−1, and thus generates a 32-bit cyclic redundancy check code CRC32_h as follows (S304).

First, the HIF controller 131 adds D32_h and CRC32_h−1 (more specifically, D32_h and CRC32₁₃ h−1 expressed in binary form) together without performing a carry operation. In other words, the HIF controller 131 adds D32_h and CRC32_h−1 together using a modulo-2 operation. The modulo-2 addition is implemented by performing an exclusive-OR operation on D32_h and CRC32_h−1. The resultant value of the exclusive-OR operation is represented as XOR32_hh−1. Then, the HIF controller 131 uses XOR32_hh−1 (more specifically, XOR32_hh−1×2³²) as a dividend, and divides the dividend XOR32_hh−1×2³² (62 bits) by a predetermined divisor (in this case, a divisor of 33 bits), for example, CRC-32 using a modulo-2 operation. The HIF controller 131 then acquires the remainder (32 bits) of the modulo-2 division as CRC32_h. When h is 1, a 32-bit CRC32_1 is generated using a CRC operation 811 based on D32_1 and CRC32_0 (=LBAij) as shown in FIG. 8.

Then, the HIF controller 131 determines whether variable h is equal to BS/32 (=4096/32=128) (S305). BS/32 is indicative of the number of small blocks providing write data block BLKij. In other words, BS/32 points to the final small block in write data block BLKij.

If variable h is not equal to BS/32 (=128) (No in S305), the HIF controller 131 determines that the CRC operation has not reached the final small bloc in write data block BLKij. In this case, the HIF controller 131 increments variable h by one (S306) so that variable h points to the next small block in write data block BLKij, and then returns to S303.

In S303, the HIF controller 131 acquires the data D32_h in the small block specified by the incremented variable h, from write data block BLKij. The HIF controller 131 then performs a CRC operation based on D32_h and CRC32_h−1, and thus generates a new CRC32_h (S304). In this case, the last generated CRC32_h is used as CRC32_h−1. As shown in FIG. 8, h is 2 in the second CRC operation, and thus, CRC32_2 is generated based on D32_2 and CRC32_1.

S303 and 5304, described above, are repeated from h=1 to h=BS/32=128. For h=BS/32=128, as shown in FIG. 8, the 128th CRC operation 813 is performed on write data block BLKij, and thus generates CRC32_128 based on D32_128 and CRC32_127. In other words, in the CRC operation 813, CRC32_128 is generated as a new CRC32_h (S304).

As described above, when variable h is BS/32 (=128) (Yes in S305), the HIF controller 131 determines that the CRC operation has been performed based on the data D32_1 to D32_128 in all the small blocks in write data block BLKij. The HIF controller 131 then sets the CRC32_h generated in the final CRC operation (=CRC32_128) as a block cyclic redundancy check code BCRCij to be added to write data block BLKij (more specifically, the data Dij in write data block BLKij) (S307). Thus, the BCRC generation process ends. The HIF controller 131 stores the BLKij provided with the generated BCRCij in the buffer memory 14 as the j^{th} write data block in the received write data sequence DSi.

As is apparent from the above-described BCRC generation process, BCRCij is a block cyclic redundancy check code with logical block address LBAij of write data block BLKij embedded therein. BS/32 (=128) CRC operations including the CRC operations 811, 812, and 813 are equivalent to a CRC operation 810 (FIG. 8) based on the data Dij in write data block BLKij (in other words, 128-byte data Dij) and logical block address LBAij. As a dividend for the CRC operation 810, the result of an exclusive-OR operation performed on Dij and LBAij is used.

Upon starting the saving process, the CPU 133 first saves a block size BS in a predetermined area in the FROM 15 (hereinafter referred to as a write data management information area) (S201). The block size BS is indicative of the size of data blocks applied in the HDD shown in FIG. 1, for example, the bit length of the data blocks. The block size BS is stored in the CPU memory 134, though this is not shown in FIG. 4. In the embodiment, the block size BS can be specified by the host and is, for example, 4,096 bits (512 bytes). When the block size BS is fixed, S201 is not necessarily required.

Then, the CPU 133 counts the number NS of write data sequences DS1, . . . , DSn not yet written to the disk 110 (S202). NS is acquired by counting the number of write data management information elements MEa1, . . . , MEan in write data management information Ma. The CPU 133 saves the number of write data sequences NS in a location succeeding the block size BS in the write data management information area in the FROM 15, for example, as shown in FIG. 4 (S203).

Then, the CPU 133 adds the numbers of write data blocks NB1, . . . , NBn included in write data management information elements MEa1, . . . , MEan, and thus calculates the total sum TNB of the numbers of write data blocks NB1, . . . , NBn (the total number of write data blocks TNB) (S204). The CPU 133 saves the total number of write data blocks TNB in a location succeeding the number of write data sequences NS in the write data management information area in the FROM 15, for example, as shown in FIG. 4 (S205).

As described above, write data management information Mb including the block size BS, the number of write data sequences NS, and the total number of write data blocks TNB is saved in the write data management information area in the FROM 15. It should be noted that, unlike write data management information Ma, write data management information Mb does not include logical block addresses LBA1 (=LBA11), . . . , LBAn (=LBAn1) of the leading write data blocks BLK11, . . . , BLKn1 in write data sequences DS1, . . . , DSn. In other words, logical block addresses LBA1, . . . , LBAn have been excluded from write data management information Mb. Hence, the embodiment enables a reduction in the amount of write data management information Mb compared to the conventional technique, enabling a reduction in the storage capacity demanded for the FROM 15. Moreover, in the embodiment, unlike write data management information Ma, write data management information Mb does not include the number of write data blocks in each write data sequence. Therefore, the embodiment enables a further reduction in the amount of write data management information compared to the conventional technique.

Then, the CPU 133 sets a variable i to an initial value of 1 (S206). Variable i is indicative of the i^{th} write data sequence DSi of write data sequences DS1, . . . , DSn not yet written to the disk 110. The CPU 133 then sets a variable j to an initial value of 1 (S207). Variable j is indicative of the j^{th} write data block BLKij of write data blocks BLKi1, . . . , BLKim(i) in write data sequence DSi. As in this example, when variable j is 1, variable j points to the leading write data block BLKil in write data sequence DSi.

Then, the CPU 133 reads write data block BLKij in write data sequence DSi from the buffer memory 14 and saves write data block BLKij in the FROM 15 (S208). Write data block BLKij saved in the FROM 15 is hereinafter sometimes represented as BLKij(Dij, BCRCij). BLKij(Dij, BCRCij) is indicative of that write data block BLKij includes the block cyclic redundancy check code BCRCij in addition to the data Dij. When both variables i and j are 1 as in this example, write data block BLKij(Dij, BCRCij) is a leading write data block BLK11(D11, BCRC11) in write data sequence DS1. Write data block BLK11(D11, BCRC11) is saved in a leading location in a predetermined area in the FROM 15, for example, an area succeeding the write data management information area (the area is hereinafter referred to as the write data area) (FIG. 4).

Then, the CPU 133 determines whether variable j is equal to the number of write data blocks NBi included in write data management information element MEai (S209). If variable j (j=1) is not equal to the number of write data blocks NBi (No in S209), the CPU 133 determines that the saving process has not reached the final write data block in write data sequence DSi. In this case, the CPU 133 increments variable j by one so that variable j points to the next write data block in write data sequence DSi (S210). The CPU 133 then executes S208, described above, on write data block BLKij specified by the current variable i and the incremented variable j. In this case, the CPU 133 saves write data block BLKij(Dij, BCRCij) in the write data area in the FROM 15 so that write data block BLKij(Dij, BCRCij) succeeds the last saved write data block BLKi(j−1)(Di(j−1), BCRCi(j−1)) in the FROM 15.

S208, described above, is repeated from j=1 to j=NBi (=m(i)). Then, variable j becomes equal to NBi (Yes in S209), and thus the CPU 133 determines that the saving process has been executed on all write data blocks BLKi1, . . . , BLKim(i) in write data sequence DSi. In this case, the CPU 133 determines whether variable i is equal to the number of write data sequences NS (S211). If variable j is not equal to the number of write data sequences NS (No in S211), the CPU 133 determines that the saving process has not reached the final write data sequence Dsn. In this case, the CPU 133 increments variable i so that variable i points to the next write data sequence (S212).

Then, the CPU 133 returns to S207, and sets variable j to an initial value of 1 so that variable j points to the leading write data block BLKi1 in write data sequence DSi pointed to by the incremented variable i. The CPU 133 executes S208, described above, on all write data blocks BLKil, . . . , BLKim(i) (m(i)=NBi) in the write data sequence pointed to by the incremented variable i. Write data blocks BLKi1, . . . , BLKim(i) are saved in the write data area in the FROM 15 so that write data blocks BLKi1, . . . , BLKim(i) succeed all write data blocks BLK(i−1)1, . . . , BLK(i−1)m(i−1) in the last saved write data sequence DS(i−1) in the FROM 15.

The CPU 133 performs the above-described operations on all the write data blocks in write data sequences DS1, . . . , DSn. Now, it is assumed that S208 has been executed on the final data block BLKnm(n) in write data sequence DSn. In this case, variable j (=m(n)=NBn) and variable i (=n=NS) are equal to NBi (=NBn) and NS, respectively (Yes in S209 and S211). Then, the CPU 133 determines that the saving process has ended.

At this time, write data sequences DS1, . . . , DSn are saved in the FROM 15 as shown in FIG. 4 and are continuous in the FROM 15. Write data sequence DS1 in the FROM 15 includes write data blocks BLK11(D11, BCRC11), . . . , BLK1m(1) (D1m(1), BCRC1m(1)). Similarly, write data sequence DSn in the FROM 15 includes write data blocks BLKnl(Dnl, BCRCn1), . . . , BLKnm(n) (Dnm(n), BCRCnm(n)).

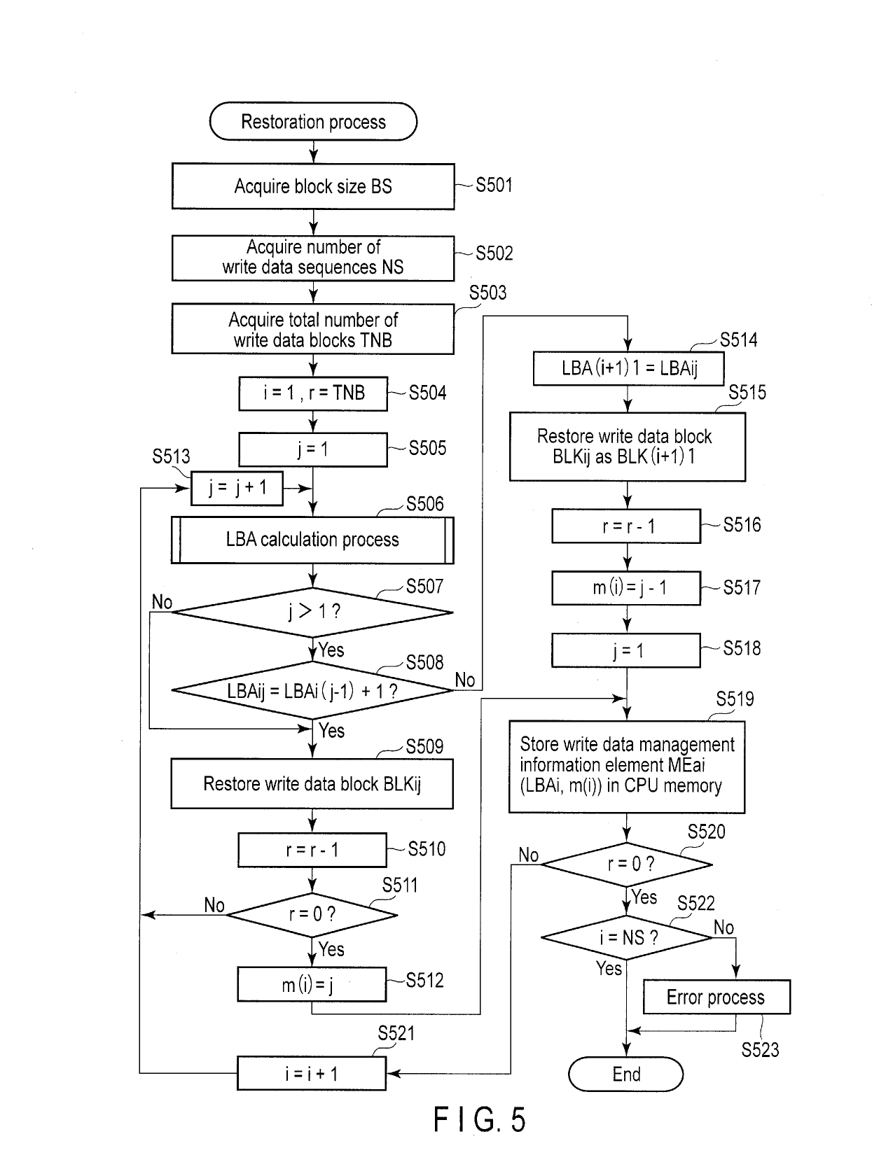

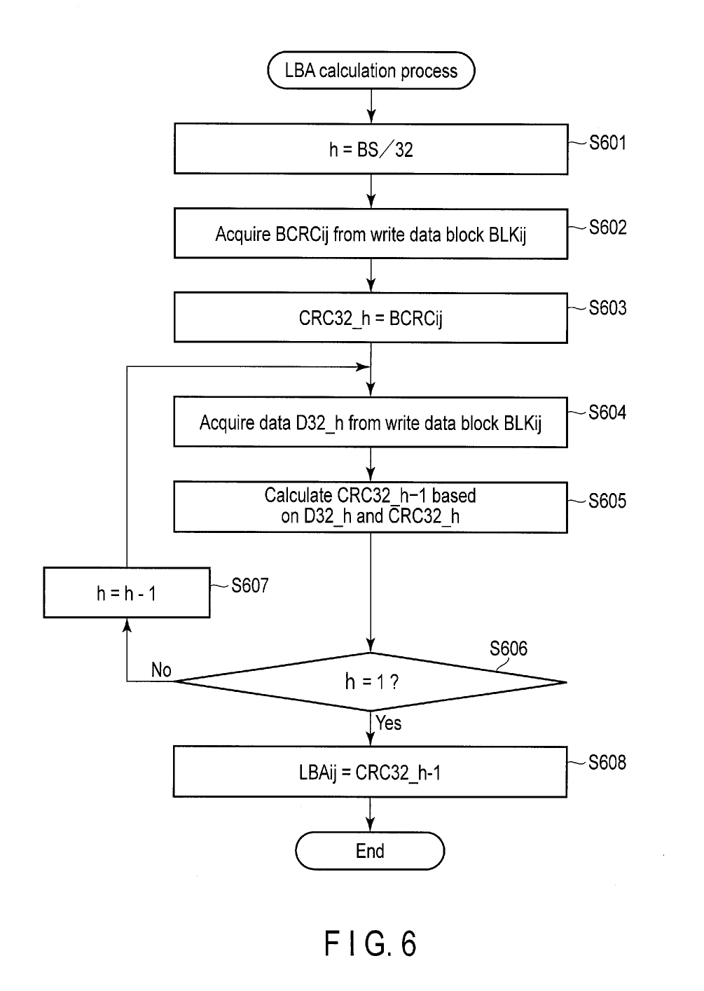

Now, a restoration process executed when the main power supply is restored in the embodiment will be described with reference to FIGS. 5 and 6 and FIG. 8 described above. FIG. 5 is a flowchart showing an exemplary procedure for the restoration process. FIG. 6 is a flowchart showing an exemplary procedure for a logical block address (LBA) calculation process included in the restoration process.

Now, it is assumed that the restoration process is started by the CPU 133. At this time, write data management information Mb and write data sequences DS1, . . . DSn are saved in the FROM 15 as shown in FIG. 4.

First, the CPU 133 acquires the block size BS, the number of write data sequences NS, and the total number of write data blocks TNB from write data management information Mb saved in the FROM 15 (S501, S502, and S503). Then, the CPU 133 sets variable i and a variable r to an initial value of 1 and TNB (total number of write data blocks), respectively (S504). Variable i is indicative of the ith write data sequence DSi of the NS (NS=n) write data sequences DS1, . . . , DSn saved in the FROM 15. Variable r is indicative of the number of write data blocks to be restored. However, in the embodiment, write data management information Mb saved in the FROM 15 does not include the number of write data blocks in each write data sequence. Thus, the CPU 133 must identify the boundary between write data sequence DSi and the succeeding write data sequence DS(i+1). The CPU 133 then sets variable j to an initial value of 1 (S505). Variable j points to the j^{th} write data block BLKij(Dij, BCRCij) in write data sequence DSi.

Then, the CPU 133 executes the LBA calculation process in accordance with a procedure shown in the flowchart in FIG. 6, as follows (S506). The LBA calculation process includes a process for calculating, based on write data block BLKij saved in the FROM 15, logical block address LBAij embedded in BCRCij added to write data block BLKij (more specifically, the data Dij in BLKij).

First, the CPU 133 sets variable h to an initial value BS/32 (S601). In the embodiment, in which BS is 4,096, the initial value BS/32 is 128. In other words, variable h is set to the initial value of 128. As is the case with the above-described saving process, variable h points to the hth small block of the 128 small blocks in write data block BLKij. For h=BS/32=128 as in this example, variable h refers to the final small block in write data block BLKij. Furthermore, when both variables i and j are 1, BLKij=BLK11. Write data block BLK11 is saved to the leading location in the write data area in the FROM 15.

Then, the CPU 133 acquires BCRCij from write data block BLKij (=BLK11) (S602). The CPU 133 sets the acquired BCRCij as CRC32_h (CRC32_128) (S603).

Then, the CPU 133 acquires the data D32_h in the h^{th} small block from write data block BLKij (S604). The CPU 133 then performs a CRC operation based on D32_h and CRC32_h, and thus calculates (restores) a 32-bit cyclic redundancy check code CRC32_h−1 as follows (S605).

First, the CPU 133 adds D32_h and CRC32_h together using a modulo-2 operation. As is well known, a modulo-2 addition is equivalent to a modulo-2 subtraction. The modulo-2 addition (subtraction) is implemented by performing an exclusive-OR operation on D32_h and CRC32_h. The resultant value of the exclusive-OR operation is represented as XOR32_hh. Then, the CPU 133 uses XOR32_hh (more specifically, XOR32_hh×2³²) as a dividend, and divides the dividend XOR32_hh×2³² (62 bits) by the divisor used for the CRC operation (S304) in the BCRC generation process using a modulo-2 operation. The CPU 133 then acquires the remainder (32 bits) of the modulo-2 division as CRC32_h−1.

In other words, the CPU 133 uses the CRC32_h resulting from the CRC operation included in the BCRC generation process and based on D32_h and CRC32_h−1, and thus performs the CRC operation (S605) based on D32_h and CRC32_h to calculate (restore) CRC32_h−1. When h=BS/32=128 as in this example, CRC32_127 results from a CRC operation 821 based on D32_128 and CRC32_128 (=BCRCij) as shown in FIG. 8.

The CPU 133 repeats 5604 and 5605 from h=BS/32=128 to h=1 (S607) in a direction opposite to the direction in the BCRC generation process (S606). Thus, given that, for example, h is 2, CRC32_1 results from a CRC operation 822 based on D32_2 and CRC32_2 as shown in FIG. 8.

It is assumed that S604 and S605 are then executed for h=1. In this case, CRC32_h−1=CRC32_0 is calculated by a CRC operation 823 based on D32_h=D32_1 and CRC32_h=CRC32_1 as shown in FIG. 8. Thus, when variable h is 1 (Yes in S606), the CPU 133 determines the CRC32_h−1 resulting from the final CRC operation (=CRC32_0) to be logical block address LBAij embedded in BCRCij added to write data block BLKij. The CPU 133 then sets the CRC32_h−1=CRC32_0 calculated by the final CRC operation to be logical block address LBAij as shown in FIG. 8 (S608). Thus, the LBA calculation process (FIG. 5, S506) ends to restore logical block address LBAij embedded in BCRCij.

BS/32 (=128) CRC operations including the CRC operations 821, 822, and 823 are equivalent to a CRC operation 820 (FIG. 8) based on the data Dij in write data block BLKij and BCRCij. The result of an exclusive-OR operation on Dij and BCRCij is used as a dividend for the CRC operation 820.

The procedure will be further described with reference back to FIG. 5. When the LBA calculation process (S506) ends, the CPU 133 determines whether variable j exceeds 1 (S507). When variable j is 1 (No in S507), the CPU 133 skips the next step S508 to proceed to S509. In S509, the CPU 133 restores write data block BLKij, in other words, write data block BLKij(Dij, BCRCij) into the buffer memory 14.

Then, the CPU 133 decrements variable r by one (S510), and thereafter determines whether the decremented variable r is equal to zero (S511). If the decremented variable r is not equal to zero (No in S511), the CPU 133 determines that r write data blocks to be restored remains in the FROM 15.

Then, the CPU 133 increments variable j by one (S513) and returns to S506. In S506, the CPU 133 executes an LBA calculation process shown in the flowchart in FIG. 6 (in this case, the TNB-r+1th LBA calculation process) for write data block BLKij indicated by the current variable i and the incremented variable j. The CPU 133 thus calculates logical block address LBAij of write data block BLKij. At this time, logical block address LBAi(j−1) of write data block BLKij has already been calculated in the last (TNB-r^{th}) LBA calculation process.

Then, the CPU 133 determines again whether variable j exceeds 1 (S507). Here, variable j exceeds 1 (Yes in S507). In this case, the CPU 133 determines whether logical block address LBAij is consecutive with logical block address LBAi(j−1) based on whether LBAij is equal to LBA1(j−1)+1 (S508).

If LBAij is consecutive with LBAi(j−1) (Yes in S508), the CPU 133 determines that write data blocks BLKi(j−1) and BLKij belong to the same write data sequence. In this case, the CPU 133 restores write data block BLKij into the buffer memory 14 as the jth write data block in write data sequence DSi (S509).

In contrast, if LBAij is not consecutive with LBAi(j−1) (No in S508), the CPU 133 determines LBAij to be the logical block address of the leading write data block BLK(i+1)1 in write data sequence DS(i+1) succeeding write data sequence DSi. The CPU 133 thus sets LBAij as LBA(i+1)1 (S514). The CPU 133 also determines LBAi(j−1) to be logical block address LBAim(i) of the final write data block BLKim(i) in write data sequence DSi. In this case, the number NBi of write data blocks in write data sequence DSi, in other words, m(i), is equal to j−1.

Thus, the CPU 133 detects a non-consecutive point in the logical block addresses calculated (restored) in the repeatedly executed LBA calculation process, and thus identifies write data sequences (more specifically, the boundary between write data sequences). That is, the embodiment allows write data sequences DS1, . . . , DSn to be identified even though the numbers of write data blocks NB1, . . . , NBn in write data sequences DS1, . . . , DSn, respectively, are not included in write data management information Mb saved in the FROM 15 (FIG. 4).

Thus, the CPU 133 restores write data block BLKij into the buffer memory 14 as the leading write data block BLK(i+1)1 in write data sequence DS(i+1) succeeding write data sequence DSi (S515). The CPU 133 then decrements variable r by one (S516), sets j−1 as the number m(i) (=NBi) of write data blocks in write data sequence DSi to (S517), and re-sets variable j to an initial value of 1 (S518).

Then, the CPU 133 stores (restores) the ith write data management information element MEai of write data management information Ma in the CPU memory 134 (S519). Write data management information element MEai includes logical block address LBAi and the number of write data blocks m(i) (=NBi). Thus, write data management information element MEai may be represented as MEai(LBAi, m(i)). Logical block address LBAi1 is used as logical block address LBAij.

Then, the CPU 133 determines whether variable r is equal to zero (S520). If variable r is not equal to zero (No in S520), the CPU 133 increments variable i by one (S521), also increments variable j by one (S513), and returns to S506. In this case, variable j that has not been incremented is set to the initial value of 1 in S518. Thus, variable j is incremented to 2 in S513.

Now, variable r decremented in S510 is assumed to be equal to zero (Yes in S511). In this case, the CPU 133 determines that all the write data blocks indicated by the total number of write data blocks TNB have been restored and that no write data block to be restored remains in the FROM 15. The CPU 133 also determines that the write data sequence DSi indicated by the current variable i is the final write data sequence and that write data block BLKij restored in the last step 509 is the final data block in the final write data sequence. The CPU 133 then sets j as the number m(i) (=NBi) of write data blocks in write data sequence DSi (S512).

Then, the CPU 133 stores write data management information element MEai in the CPU memory 134 (S519), and thereafter determines whether variable r is equal to zero (S520). If variable r is equal to zero as in this example (Yes in S520), the CPU 133 determines whether variable i is equal to the number of write data sequences NS (S522).

If variable i is equal to the number of write data sequences NS (Yes in S522), the CPU 133 determines that the write data sequences have been correctly identified based on detection of the non-consecutive point in the restored logical block addresses. This is indicative of that the logical block addresses of the write data blocks have been correctly restored based on the number of write data sequences NS, the total number of write data blocks TNB, and all the write data blocks (data items and block cyclic redundancy check codes) included in the write data sequences, and thus also that the write data sequences (all the write data blocks) have been normally restored. Thus, the CPU 133 ends the restoration process.

In contrast, if variable i is not equal to the number of write data sequences NS (Yes in S522), the CPU 133 determines that the write data sequences have not been correctly identified. Incorrect identification is indicative of that at least some of the logical block addresses of all the write data blocks included in the write data sequences have not been normally restored, and thus also that at least some of the write data sequences have not been normally restored. Thus, the CPU 133 executes an error process (S523). The error process includes a notification of a failure in restoration to the host.

When the restoration fails, variable i may exceed the number of write data sequences NS before variable r becomes equal to zero. Thus, when variable r is not equal to zero (No in S520), the CPU 133 may determine, before the next step S521, whether variable i exceeds the number of write data sequences NS. In this case, if variable i exceeds the number of write data sequences NS, the error process (S523) may be executed. Otherwise, S521 may be executed. This allows the failure in restoration to be quickly detected, enabling a reduction in needless processes otherwise executed when the restoration fails.

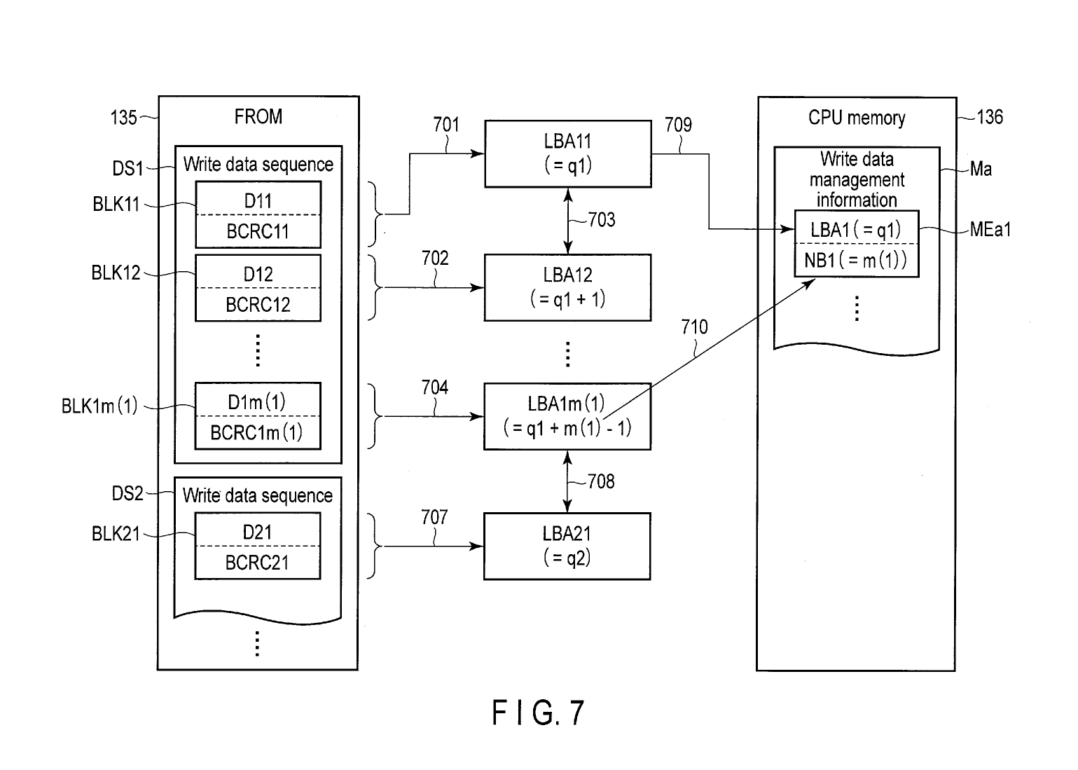

FIG. 7 is a diagram illustrating the above-described restoration process. In the example shown in FIG. 7, first, an LBA calculation process denoted by arrow 701 (S506 in FIG. 5) is executed based on the data D11 and block cyclic redundancy check code BCRC11 in the leading write data block BLK11 in write data sequence DS1 saved in the FROM 15. Thus, logical block address LBA11 of write data block BLK11 is calculated. A decimal value for logical block address LBA11 is assumed to be q1.

Then, an LBA calculation process denoted by arrow 702 (S506 in FIG. 5) is executed based on D12 and BCRC12 in the second BLK12 in DS1, and thus logical block address LBAl2 of BLK12 is calculated. A decimal value for LBA12 is assumed to be q1+1. In a determination process denoted by arrow 703 (S508 in FIG. 5), whether LBAl2 is consecutive with LBA11 is determined based on whether LBAl2 is equal to LBA11+1. In this case, it is assumed to determine that LBAl2 is consecutive with LBA11.

It is assumed that, after similar processes are subsequently executed, an LBA calculation process denoted by arrow 704 (S506 in FIG. 5) is executed based on D1m(1) and BCRC1m(1) in the m(1)th BLK1m(1) in DS1, and thus logical block address LBA1m(1) of BLK1m(1) is calculated. A decimal value for LBA1m(1) is assumed to be q1+m(1)−1. Furthermore, it is assumed that LBA1m(1) is consecutive with LBA1(m(1)−1).

It is assumed that an LBA calculation process denoted by arrow 707 (S506) is then executed based on D21 and BCRC21 in the leading BLK21 in DS2, and thus logical block address LBA21 of BLK21 is calculated. A decimal value for LBA21 is assumed to be q2. In a determination process denoted by arrow 708 (S508), whether LBA21 is consecutive with LBA1m(1) is determined based on whether LBA21 is equal to LBA1m(1)+1. However, at this point in time, the CPU 133 does not identify the boundary between DS1 and DS2. Thus, in actuality, the CPU 133 processes D21 and BCRC21 in BLK21 in DS2 as D1(m(1)+1) and BCRC1(m(1)+1) in BLK1(m(1)+1) in DS1.

Now, it is assumed that LBA21 has been determined not to be consecutive with LBA1m(1). In other words, it is assumed LBA1(m(1)+1) has been determined to not to be consecutive with LBA1m(1). In this case, the CPU 133 determines that LBA1m(1) is LBA of the final write data block BLK1m(1) in DS1 and that LBA1(m(1)+1) is LBA of the leading write data block BLK21 in DS2 succeeding DS1, in other words, LBA21. Thus, the CPU 133 sets LBA1(m(1)+1) as LBA21 (S514 in FIG. 5). The CPU 133 then restores write data management information element MEa1 including LBA11 (=q1) and m(1) as LBA1 and NB1, respectively, into the CPU memory 134, as shown by arrows 709 and 710 in FIG. 7 (S519 in FIG. 5).

### <Modification>

The logical block address applied in the embodiment has a bit length of 32. In this case, the maximum storage capacity that can be supported by the HDD is approximately 2 TB as described above. Thus, logical block addresses exceeding 32 bits must be applied in order to enable the HDD to support a storage capacity exceeding 2 TB.

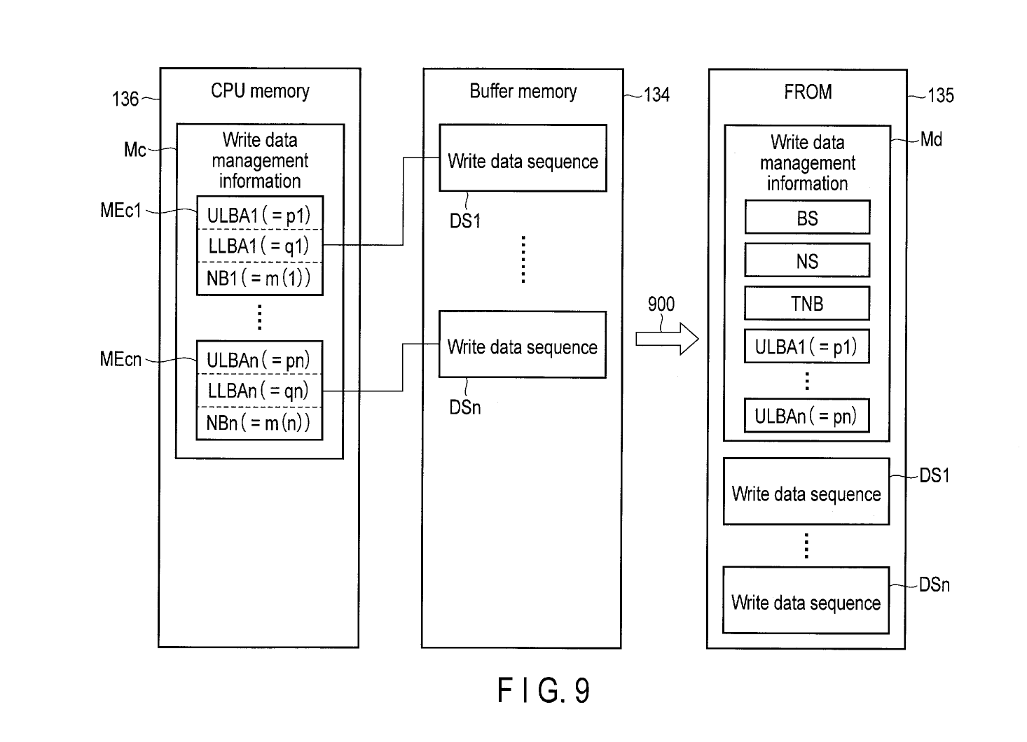

A modification of the embodiment will be described below taking as an example a case where logical block addresses applied in the modification have a bit length of 64 and focusing on differences from the embodiment. First, a saving process in the modification will be described with reference to FIG. 9 and FIGS. 2 and 3 described above. FIG. 9 a diagram showing an example of the contents of the buffer memory 14 and the CPU memory 134 on which the saving process shown by arrow 900 has not been executed and the contents of the FROM 15 on which the saving process has been executed, in the modification.

Now, it is assumed that the saving process is started by the CPU 133. It is assumed that, at this time, write data sequences DS1, . . . , DSn are stored in the buffer memory 14 (FIG. 9) and is not yet written to the disk 110 as is the case with the embodiment. On the other hand, it is assumed that write data management information Mc for write data sequences DS1, . . . , DSn is stored in the CPU memory 134.

Write data management information Mc includes write data management information elements MEc1, . . . , MEcn corresponding to write data sequences DS1, . . . , DSn. As shown in FIG. 9, the elements MEc1, . . . , MEcn include upper logical block addresses ULBA1 (=p1), . . . , ULBAn (=pn), lower logical block addresses LLBA1 (=q1), . . . , LLBAn (=qn), and the numbers of write data blocks NB1 (=m(1)), . . . ,NBn (=m(n)), respectively.

The upper logical block address ULBAi (i=1, . . . , n) is indicative of upper 32 bits of the 64-bit logical block address. The lower logical block address LLBAi is indicative of lower 32 bits of the 64-bit logical block address. In other words, the 64-bit logical block address LBAi comprises ULBAi and LLBAi. Similarly, the 64-bit logical block address LBAij comprises ULBAij and LLBAij. LLBAi and LLBAij correspond to the 32-bit logical block addresses LBAi and LBAij in the embodiment, respectively.

As in the modification, when the bit length of logical block address LBAij is 64, in other words, the bit length exceeds 32, the 64-bit logical block address LBAij fails to be embedded in BCRCij, which is 32 bits in bit length. Thus, in a BCRC generation process in the modification, the HIF controller 131 embeds the lower logical block address LLBAij of the 64-bit logical block address LBAij in BCRCij, which is 32 bits in bit length.

Furthermore, in the saving process in the modification, the CPU 133 saves write data management information Md including upper logical block addresses ULBA1, . . . , ULBAn in write data management information elements Mec1, . . . , Mecn, in the FROM 15. Such a saving process in the modification is implemented by adding a lower logical block address saving process to the flowchart shown in FIG. 2. In the modification, the CPU 133, for example, executes the lower logical block address saving process between S205 and S206 in the flowchart shown in FIG. 2. Thus, the CPU 133 saves upper logical block addresses ULBA1, . . . , ULBAn in write data management information element MEc1, . . . , MEcn stored in the CPU memory 134, for example, in a location succeeding the total number of write data blocks TNB in the FROM 15. Each time variable i is operated in accordance with the flowchart shown in FIG. 2 (S206 or S212), the CPU 133 may save the upper logical block address ULBAi in write data management information element MEci pointed to by variable i, in the FROM 15.

Now, a restoration process in the modification will be described with reference to FIGS. 5 and 6, described above. The restoration process in the modification is executed in accordance with the procedure shown in the flowchart in FIG. 5. Furthermore, the LBA calculation process in the modification included in the restoration process is executed in accordance with the procedure shown in FIG. 6 as is the case with the above-described embodiment. However, in 5508 in FIG. 5, LBAij and LBAi(j−1) must be replaced with LLBAij and LLBAi(j−1), respectively. In this case, the carry is neglected, and when, for example, LLBAij is 00000000h in hexadecimal form, if LBAi(j−1) is FFFFFFFFh, LLBAij is equal to LBAi(j−1)+1. Thus, LLBAij is determined to be consecutive with LLBAi(j−1). Furthermore, in S514 in FIG. 5, LBA(i+1)1 must be replaced with LLBA(i+1)1. In S606 in FIG. 6, LBAij must be replaced with LLBAij.

Moreover, in S519 in FIG. 6, write data management information element MEai(LBAi, m(i)) must be replaced with write data management information element MEci(ULBAi, LLBAi, m(i)). In other words, in S519 (more specifically, the process corresponding to S519), the CPU 133 restores write data management information element MEci comprising ULBAi, LLBAi, and m(i) (NBi=m(i)), in the CPU memory 134. In this regard, ULBAi is acquired from write data management information Md saved in the FROM 15.

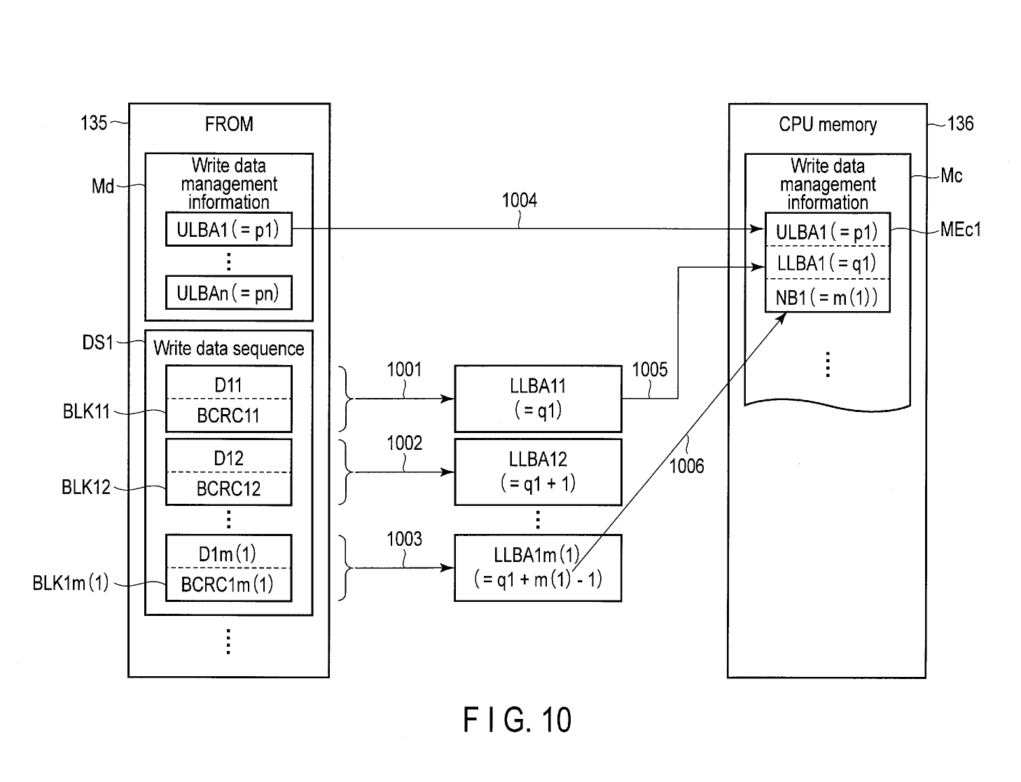

FIG. 10 is a diagram illustrating the above-described restoration process in the modification. In the example shown in FIG. 10, first, an LBA calculation process shown by arrow 1001 (S506) is executed based on the data D11 and block cyclic redundancy check code BCRC11 in the leading write data block BLK11 in write data sequence DS1. Thus, the lower 32 bits LLBA11 of logical block address LBA11 of write data block BLK11 are calculated. A decimal value for LLBA11 is assumed to be q1.

Then, an LBA calculation process shown by arrow 1002 (S506) is executed based on D12 and BCRC12 in the second write data block BLK12 in DS1, and thus the lower 32 bits LLBAl2 of logical block address LBA12 of BLK12 is calculated. A decimal value for LLBA12 is assumed to be q1+1.

It is assumed that, after similar processes are subsequently executed, an LBA calculation process denoted by arrow 1003 (S506 in FIG. 5) is executed based on D1m(1) and BCRC1m(1) in the m(1)th write data block BLK1m(1) in DS1, and thus the lower 32 bits LLBA1m(1) of logical block address LBA1m(1) of BLK1m(1) is calculated. A decimal value for LLBA1m(1) is assumed to be q1+m(1)−1. Furthermore, it is assumed that LLBA1m(1) is consecutive with LLBA1(m(1)−1). Similarly, following LLBA1m(1), LLBA1(m(1)+1) is calculated. A decimal value for LLBA1(m(1)+1) is assumed to be q2.

Now, it is assumed that the CPU 133 determines that LLBA1(m(1)+1) is not equal to LLBA1m(1)+1 and thus that LLBA1(m(1)+1) is not consecutive with LLBA1m(1). In this case, the CPU 133 determines that LLBA1m(1) is LLBA of the final write data block BLK1m(1) in DS1 and that LLBA1(m(1)+1) is LLBA of LBA of the leading write data block BLK21 in DS2 succeeding DS1, in other words, LLBA21. Thus, the CPU 133 sets LLBA1(m(1)+1) as LLBA21. Moreover, the CPU 133 restores write data management information element MEc1(ULBA1, LLBA1, NB1) including ULBA1 in write data management information Md saved in the FROM 15, into the CPU memory 134 as shown by arrow 1004 in FIG. 10. Write data management information element MEc1(ULBA1, LLBA1, NB1) includes LLBA11 and m(1) as LLBA1 and NB1, as shown by arrows 1005 and 1006 in FIG. 10.

The above-described at least one embodiment enables a reduction in the amount of write data management information saved in the nonvolatile memory in accordance with a decrease in main power supply voltage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a first volatile memory;
a nonvolatile memory; and
a controller configured to save a write data sequence including a plurality of write data blocks not written to a disk, and first management information, for the plurality of write data blocks, from which logical block addresses are excluded, in the nonvolatile memory in response to a decrease in a voltage of a power supply for the magnetic disk device, the plurality of write data blocks being externally transferred and stored in the first volatile memory and added with redundancy codes respectively, the redundancy codes being associated with the plurality of write data blocks respectively, and logical block addresses of the plurality of write data blocks being embedded in the redundancy codes respectively.

2. The magnetic disk device of claim 1, wherein the redundancy codes are generated respectively, based on data items in the plurality of write data blocks and the logical block addresses of the plurality of write data blocks.

3. The magnetic disk device of claim 1, further comprising a second volatile memory,
wherein:
a plurality of write data sequences is stored in the first volatile memory, and second management information is stored in the second volatile memory, the second management information including, as a set, logical block addresses of leading write data blocks included in the plurality of write data sequences respectively and first numbers of write data blocks included in the plurality of write data sequences respectively;
the first management information includes a second number indicative of a number of the plurality of write data sequences and a third number indicative of a sum of the first numbers; and wherein
the controller is further configured to acquire, based on the set in the second management information, the logical block addresses of the write data blocks included in the plurality of write data sequences respectively.

4. The magnetic disk device of claim 3, wherein the controller is further configured to:
sequentially restore the third number of the logical block addresses of the plurality of write data blocks based on the redundancy codes and the data items acquired, respectively, from the plurality of write data blocks included in the plurality of write data sequences saved in the nonvolatile memory;
restore the plurality of write data sequences including the plurality of write data blocks into the first volatile memory; and
restore the second management information into the second volatile memory based on the first management information and the restored logical block addresses.

5. The magnetic disk device of claim 4, wherein the controller is further configured to:
identify the plurality of write data sequences by detecting a non-consecutive point in the restored logical block addresses; and
determine whether restoration is successful based on a number of the identified write data sequences and the second number.

6. The magnetic disk device of claim 1, wherein:
the redundancy codes have a first bit length;
each of the logical block addresses of the plurality of write data blocks has a second bit length, and the second bit length is larger than the first bit length by a third bit length; and
the controller is further configured to:
embed lower logical block addresses of the logical block addresses of the plurality of write data blocks in the redundancy codes respectively, a bit length of each of the lower logical block addresses being equal to the first bit length; and
include upper logical block addresses of the logical block addresses of the plurality of write data blocks in the first management information, a bit length of each of the upper logical block addresses being equal to the third bit length.

7. The magnetic disk device of claim 6, wherein the redundancy codes are generated respectively, based on data items in the plurality of write data blocks and the lower logical block addresses.

8. The magnetic disk device of claim 7, further comprising a second volatile memory,
wherein:
a plurality of write data sequences is stored in the first volatile memory, and second management information is stored in the second volatile memory, the second management information including, as a set, upper and lower logical block addresses of leading write data blocks included in the plurality of write data sequences respectively and first numbers of write data blocks included in the plurality of write data sequences respectively;
the first management information includes a second number indicative of a number of the plurality of write data sequences, a third number indicative of a sum of the first numbers, and the upper logical block addresses of the logical block addresses of the leading write data blocks; and wherein
the controller is further configured to acquire, based on the set in the second management information, the lower logical block addresses of the logical block addresses of the write data blocks included in the plurality of write data sequences respectively.

9. The magnetic disk device of claim 8, wherein the controller is further configured to:
sequentially restore the third number of the lower logical block addresses of the logical block addresses of the plurality of write data blocks based on the redundancy codes and the data items acquired, respectively, from the plurality of write data blocks included in the plurality of write data sequences saved in the nonvolatile memory;
restore the plurality of write data sequences including the plurality of write data blocks into the first volatile memory; and
restore the second management information into the second volatile memory based on the first management information and the restored lower logical block addresses.

10. The magnetic disk device of claim 9, wherein the controller is further configured to:
identify the plurality of write data sequences by detecting a non-consecutive point in the restored lower logical block addresses; and
determine whether restoration is successful based on a number of the identified write data sequences and the second number.

11. A method, in a magnetic disk device comprising a first volatile memory and a nonvolatile memory, for saving management information, the method comprising:
saving a write data sequence including a plurality of write data blocks not written to a disk, in the nonvolatile memory in response to a decrease in a voltage of a power supply for the magnetic disk device, the plurality of write data blocks being externally transferred and stored in the first volatile memory and added with redundancy codes respectively, the redundancy codes being associated with the plurality of write data blocks respectively, and logical block addresses of the plurality of write data blocks being embedded in the redundancy codes respectively; and
saving first management information, for the plurality of write data blocks, from which logical block addresses are excluded, in the nonvolatile memory in response to a decrease in the voltage of the power supply for the magnetic disk device.

12. The method of claim 11, wherein the redundancy codes are generated respectively, based on data items in the plurality of write data blocks and the logical block addresses.

13. The method of claim 11, wherein:
the magnetic disk device further comprises a second volatile memory;
a plurality of write data sequences is stored in the first volatile memory, and second management information is stored in the second volatile memory, the second management information including, as a set, logical block addresses of leading write data blocks included in the plurality of write data sequences respectively and first numbers of write data blocks included in the plurality of write data sequences respectively
the first management information includes a second number indicative of a number of the plurality of write data sequences and a third number indicative of a sum of the first numbers; and
the method further comprises acquiring, based on the set in the second management information, the logical block addresses of the write data blocks included in the plurality of write data sequences, respectively.

14. The method of claim 13, further comprising:
sequentially restoring the third number of the logical block addresses of the plurality of write data blocks based on the redundancy codes and the data items acquired, respectively, from the plurality of write data blocks included in the plurality of write data sequences saved in the nonvolatile memory;
restoring the plurality of write data sequences including the plurality of write data blocks into the first volatile memory; and
restoring the second management information into the second volatile memory based on the first management information and the restored logical block addresses.

15. The method of claim 14, further comprising:
identifying the plurality of write data sequences by detecting a non-consecutive point in the restored logical block addresses; and
determining whether restoration is successful based on whether a number of the identified write data sequences is equal to the second number.

16. The method of claim 11, wherein:
the redundancy codes have a first bit length;
each of the logical block addresses of the plurality of write data blocks has a second bit length, and the second bit length is larger than the first bit length by a third bit length; and
the method further comprises:
embedding lower logical block addresses of the logical block addresses of the plurality of write data blocks in the redundancy codes respectively, a bit length of each of the lower logical block addresses being equal to the first bit length; and
including upper logical block addresses of the logical block addresses of the plurality of write data blocks in the first management information, a bit length of each of the upper logical block addresses being equal to the third bit length.

17. The method of claim 16, wherein the redundancy codes are generated respectively, based on data items in the plurality of write data blocks and the lower logical block addresses.

18. The method of claim 17, wherein:
the magnetic disk device further comprises a second volatile memory;
a plurality of write data sequences is stored in the first volatile memory, and second management information is stored in the second volatile memory, the second management information including, as a set, upper and lower logical block addresses of leading write data blocks included in the plurality of write data sequences respectively and first numbers of write data blocks included in the plurality of write data sequences respectively;
the first management information includes a second number indicative of a number of the plurality of write data sequences, a third number indicative of a sum of the first numbers, and the upper logical block addresses of the logical block addresses of the leading write data blocks; and
the method further comprises acquiring, based on the set in the second management information, the lower logical block addresses of the logical block addresses of the write data blocks included in the plurality of write data sequences respectively.

19. The method of claim 18, further comprising:
sequentially restoring the third number of the lower logical block addresses of the logical block addresses of the plurality of write data blocks based on the redundancy codes and the data items acquired, respectively, from the plurality of write data blocks included in the plurality of write data sequences saved in the nonvolatile memory;
restoring the plurality of write data sequences including the plurality of write data blocks into the first volatile memory; and
restoring the second management information into the second volatile memory based on the first management information and the restored lower logical block addresses.

20. The method of claim 19, further comprising:
identifying the plurality of write data sequences by detecting a non-consecutive point in the restored lower logical block addresses; and
determining whether restoration is successful based on a number of the identified write data sequences and the second number.
